(19) United States
(12) Patent Application Publication
(10) Pub. No.: US 2015/0125017 A1
(43) Pub. Date: May 7, 2015

(54) HEARING DEVICE USING MULTIPLE BATTERIES AND METHOD OF MANAGING POWER OF HEARING DEVICE

(71) Applicant: Samsung Electronics Co., Ltd., Suwon-si (KR)

(72) Inventors: Jun Whon UHM, Anyang-si (KR); Jong Jin KIM, Hwaseong-si (KR); Dong Wook KIM, Seoul (KR)

(73) Assignee: SAMSUNG ELECTRONICS CO., LTD., Suwon-si (KR)

(21) Appl. No.: 14/219,114

(22) Filed: Mar. 19, 2014

(30) Foreign Application Priority Data
Nov. 6, 2013 (KR) 10-2013-0133984

(51) Int. Cl. H04R 25/00; H04R 1/10

(52) U.S. Cl. CPC H04R 25/30; H04R 1/1091; H04R 2225/33
USPC 381/323

(57) ABSTRACT

A hearing device using multiple batteries and a method of managing power of the hearing device are disclosed, and the method of managing power of a hearing device may include determining, at a processor, to charge an auxiliary battery based on comparing power information of a main battery to power information of the auxiliary battery, and selecting a battery to supply power to the hearing device based on the power information of the main battery.

### RELATED APPLICATIONS

This application claims the benefit under 35 USC 119(a) of Korean Patent Application No. 10-2013-0133984, filed on Nov. 6, 2013, in the Korean Intellectual Property Office, the entire disclosure of which is incorporated herein by reference for all purposes.

### BACKGROUND

1. Field

The following description relates to technology for managing a hearing device.

2. Description of Related Art

A hearing device may refer to a device aiding a user wearing the hearing device in hearing sounds generated around the user. The hearing device may receive a sound wave through a microphone. The hearing device may convert, amplify, and output the received sound wave. Due to developments in integrated circuits (ICs) and hearing device fitting technology, the hearing device may provide gain and output suitable for a form and a degree of hearing loss. In addition, a size of the hearing device has been reduced. The hearing device may be provided in various forms, for example, a glass type being provided in a frame of an eyeglass, a behind-the-ear (BTE) type being hung from an ear, and a completely in the canal (CIC) type being inserted completely in an ear. In general, such types of the hearing device may operate with a small-sized battery inserted in the hearing device. A hearing device may use, for example, a zinc-air battery, as a primary cell. In a case of the hearing device using this type of the primary cell, the battery may need to be replaced frequently. Also, the hearing device may use a secondary cell. However, a battery using the secondary cell may have limited capacity, and thus, the battery may need to be charged frequently.

In a case of the hearing device, for example, a hearing aid, it may not be easy to measure an expected duration for usage of a battery, or an amount of power remaining in the battery. Although a method of providing an alarm to a user when an amount of power of the hearing device is insufficient is known, technology for increasing a battery usage time itself is desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of managing power of a hearing device, the method including determining, at a processor, to charge an auxiliary battery based on comparing power information of a main battery to power information of the auxiliary battery, and selecting a battery to supply power to the hearing device based on the power information of the main battery.

The determining to charge an auxiliary battery may include determining to charge an auxiliary battery based on detecting the power information of the main battery and the power information of the auxiliary battery.

The determining to charge an auxiliary battery may include charging the auxiliary battery, in response to the power information of the main battery being greater than the power information of the auxiliary battery.

The charging of the auxiliary battery may include charging the auxiliary battery by supplying the power from the main battery to the auxiliary battery.

The method may include discontinuing the charging of the auxiliary battery, in response to the power information of the main battery being less than or equal to the power information of the auxiliary battery.

The selecting of the battery to supply power may include supplying power from the main battery to the hearing device, in response to the power information of the main battery being greater than a predetermined threshold value.

The selecting of the battery to supply power may include supplying power from the auxiliary battery to the hearing device, in response to the power information of the main battery being less than or equal to the predetermined threshold value.

In another general aspect, there is provided a hearing device including an auxiliary battery configured to store power for operating the hearing device, a main battery configured to charge the auxiliary battery based on power information of the main battery and power information of the auxiliary battery, and a battery selector configure to select a battery to supply power to the hearing device based on the power information of the main battery.

The device may include a power information detector configured to detect the power information of the main battery and the power information of the auxiliary battery.

The device may include a charge switch configured to control charging of the auxiliary battery with power from the main battery, in response to the power information of the main battery being greater than the power information of the auxiliary battery.

The charge switch may be further configured to discontinue the charging of the auxiliary battery with the power from the main battery, in response to the power information of the main battery being less than or equal to the power information of the auxiliary battery.

The battery selector may be configured to select the main battery to supply power to the hearing device.

The battery selector may be further configured to select the auxiliary battery to supply power to the hearing device, in response to the power information of the main battery being less than or equal to a predetermined threshold value.

The power information may include at least one of a voltage, a current, or a power level of each battery.

The device may include a signal processor configured to process an auditory signal by receiving power from at least one of the main battery or the auxiliary battery.

The signal processor may include a microphone (MIC), an analog-to-digital converter (ADC), a digital signal processor (DSP), a digital-to-analog converter (DAC), and a receiver (REC).

The auxiliary battery may be a rechargeable battery configured to be charged wirelessly.

The main battery comprises a plurality of cells, and at least one cell may be a rechargeable cell configured to be charged wirelessly.

In another general aspect, there is provided a hearing device including an auxiliary battery configured to store power for operating the hearing device, a main battery configured to store power for operating the hearing device and for charging the auxiliary battery, and a signal processor configured to process an auditory signal by receiving power from at least one of the main battery or the auxiliary battery.

The signal processor may be further configured to select a battery to operate the hearing device based on power information of the main battery and to determine whether to charge the auxiliary battery based on the power information of the main battery and power information of the auxiliary battery.

Other features and aspects will be apparent from the following detailed description, the drawings, and the claims.

### BRIEF DESCRIPTION OF THE DRAWINGS

FIG. 1 is a diagram illustrating an example of a method of managing power of a hearing device.

FIG. 2 is a diagram illustrating an example of a method of determining whether to charge a battery of a hearing device.

FIG. 3 is a diagram illustrating an example of a method of selecting a battery of a hearing device.

FIG. 4 is a diagram illustrating another example of a method of managing power of a hearing device.

FIG. 5 is a diagram illustrating an example of a configuration of a hearing device.

FIG. 6 is a diagram illustrating another example of a configuration of a hearing device.

FIG. 7 is a diagram illustrating an example of a signal processor of a hearing device.

Throughout the drawings and the detailed description, unless otherwise described, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

A hearing device may refer to a device aiding a user in hearing and may include, for example, a hearing aid. The hearing device may include all devices that are detachably fixed to or in close contact with an ear of a user to provide the user with audio signals based on a sound generated outside the ear. The hearing device may include a hearing aid that amplifies an audio signal generated from an external source and aids the user in perceiving the audio signal. The hearing device may include or be included in a system supporting a hearing aid function. Such a system may include, but is not limited to, a mobile device, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a television (TV), a high definition television (HDTV), an optical disc player, a DVD player, a Blue-ray player, a setup box, any other, consumer electronics/information technology (CE/IT) device, a plug-in accessory or a hearing aid module having a sound or broadcasting relay function for a hearing aid, and a hearing aid chip.

A chargeable auxiliary battery may be provided in the hearing device. When an existing main battery is discharged, the auxiliary battery may supply continuous power to the hearing device to enable uninterrupted operation of the hearing device. The main battery may refer to a replaceable battery that is easily attached to and detached from the hearing device. The main battery and the auxiliary battery may include at least one of the primary cell and the secondary cell. When the main battery is discharged, the user may replace the discharged main battery with a spare battery carried by the user, while the auxiliary battery supplies power to the hearing device and thus, the hearing device may operate without interruption.

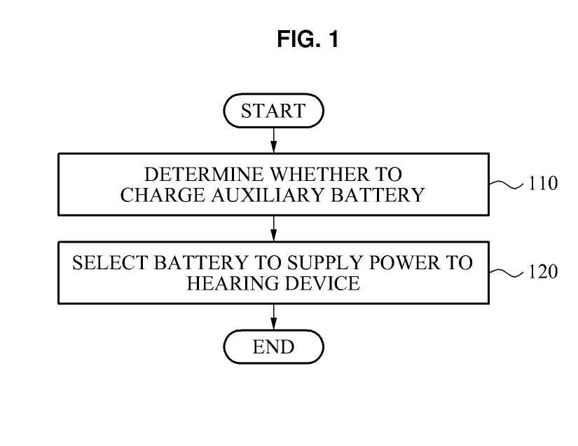

FIG. 1 is a diagram illustrating an example of a method of managing power of a hearing device. The operations in FIG. 1 may be performed in the sequence and manner as shown, although the order of some operations may be changed or some of the operations omitted without departing from the spirit and scope of the illustrative examples described. Many of the operations shown in FIG. 1 may be performed in parallel or concurrently.

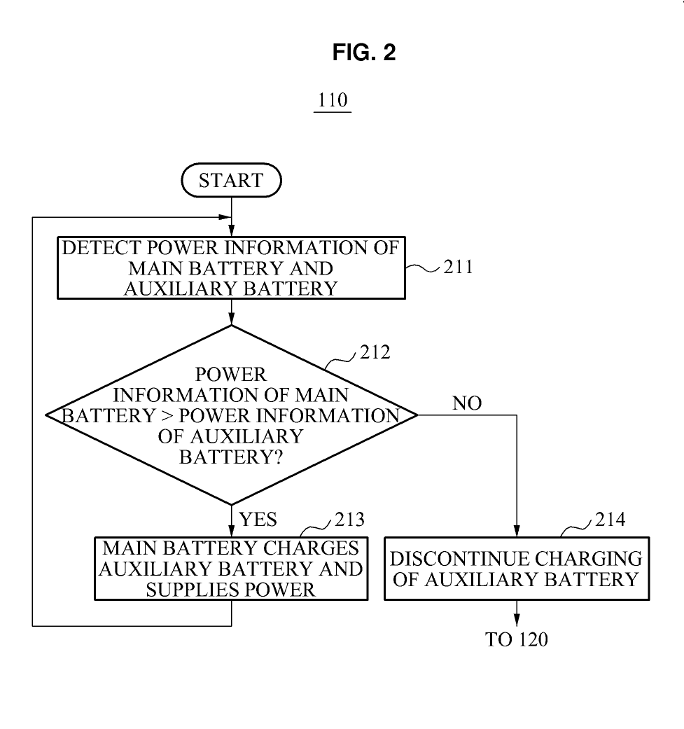

Referring to FIG. 1, in 110, a power information detector or a signal processor determines whether to charge an auxiliary battery. For example, the power information detector or the signal processor determines whether to charge the auxiliary battery based on a result of comparing power information of a main battery to power information of the auxiliary battery. A detailed description of this process is provided with reference to FIG. 2.

The power information may refer to information on power stored in the main battery and the auxiliary battery and may include information such as, for example, voltage, current, a power level of each of the main battery, and the auxiliary battery.

When the power information detector or the signal processor determines that the auxiliary battery should be charged, the main battery may supply power to the auxiliary battery through a charge switch, but the charging of the auxiliary battery is not limited to such a method of supplying power. Other methods of supplying power to the auxiliary battery, such as, for example charging the auxiliary battery from an external source through wired and wireless power transmission may be used without departing from the spirit and scope of the illustrative examples described.

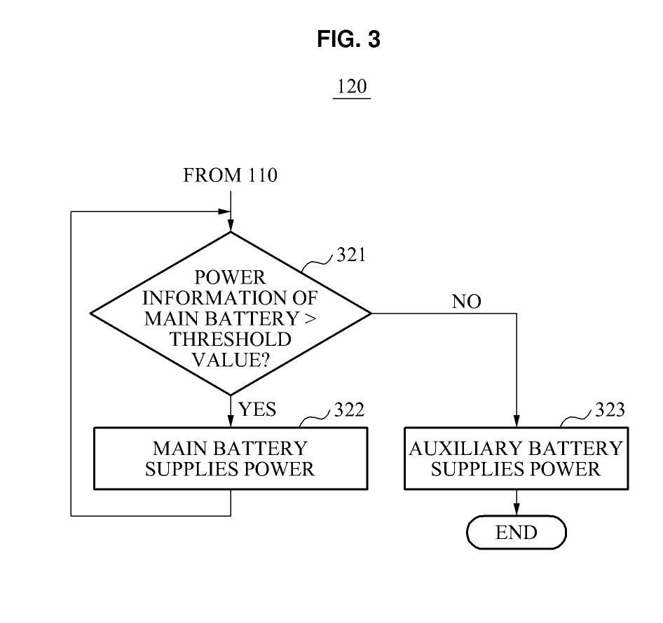

In 120, a battery selector may select a battery to supply power to the hearing device. For example, the battery selector may select the battery to supply power to the hearing device, between the main battery and the auxiliary battery, based on the power information of the main battery. A detailed description of this process is provided with reference to FIG. 3.

The battery selected by the battery selector, between the main battery and the auxiliary battery, may supply power to operate the hearing device. For example, when the power of the main battery is discharged, the auxiliary battery may supply power to the hearing device.

In an example, the hearing device using multiple batteries may include a signal processor similar to a hearing aid system, a unit for determining voltages of the main battery and the auxiliary battery, and a charge switch to connect the main battery and the auxiliary battery. The unit for determining the voltages may refer to an additional circuit, for example, the power information detector, or a digital signal processor (DSP) of the signal processor.

For example, when the main battery is provided in the hearing device, the unit for determining the voltage may compare a voltage of the main battery to a voltage of the auxiliary battery. When the voltage of the main battery is greater than the voltage of the auxiliary battery, the main battery may supply the voltage to the signal processor of the hearing device and simultaneously charge the auxiliary battery. The power of the main battery may be supplied to the auxiliary battery to charge the auxiliary battery.

In an example, when the voltage of the auxiliary battery increases to a level higher than the voltage of the main battery after the auxiliary battery is charged, or when the voltage of the auxiliary battery exceeds a predetermined voltage, the main battery may discontinue charging of the auxiliary battery, and the main battery may supply the voltage only to the signal processor.

For example, when the voltage of the main battery is greater than a predetermined threshold value, for example, 0.9 volts (V), the main battery may supply the voltage to the signal processor. When the voltage of the main battery is less than or equal to the predetermined threshold value, the main battery and the signal process may be electrically separated and the auxiliary battery may supply the voltage to the signal processor.

A detailed method of managing power of the hearing device using multiple batteries by operating the batteries will be described with reference to FIGS. 2 through 7.

FIG. 2 is a diagram illustrating an example of a method of determining whether to charge a battery of a hearing device. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. The above descriptions of FIG. 1, is also applicable to FIG. 2, and is incorporated herein by reference. Thus, the above description may not be repeated here.

Referring to FIG. 2, in 211, a power information detector detects power information of a main battery and power information of an auxiliary battery. For example, the power information detector may detect voltages of the main battery and the auxiliary battery. The estimate of an amount of power remaining in each battery may be based on the detected voltages of the batteries.

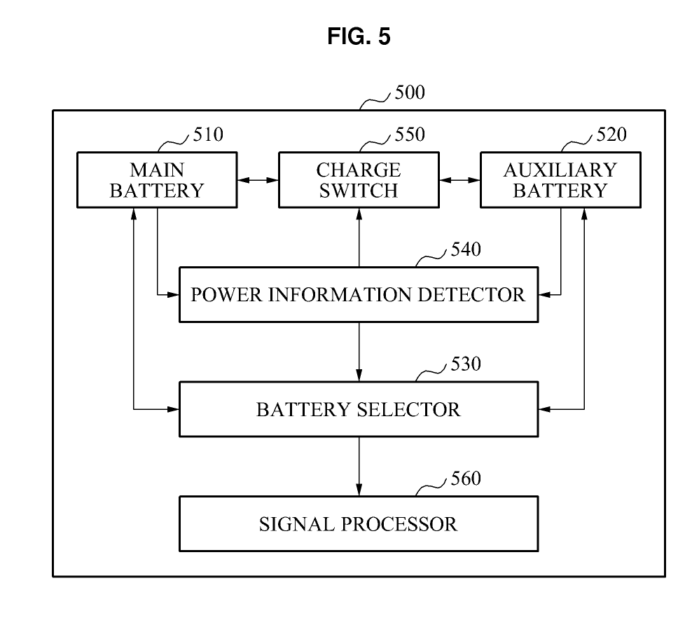

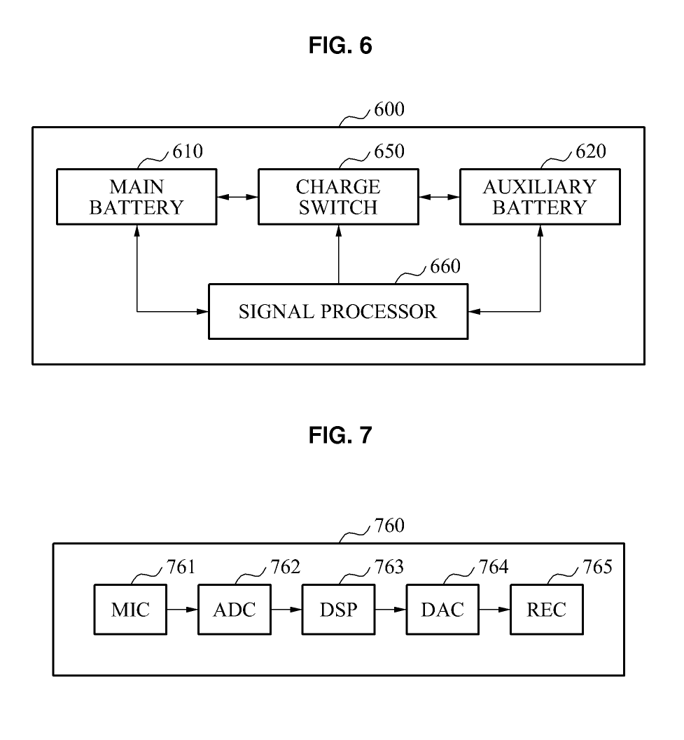

In 212, the power information of the main battery is compared to the power information of the auxiliary battery. In an example, the power information detector may compare the power information or a signal processor may directly compare the power information. A detailed description of comparing power information is provided with reference to FIGS. 5 and 6.

In 213, when the power information of the main battery is greater than the power information of the auxiliary battery, the main battery charges the auxiliary battery and supplies power to the hearing device. For example, when a voltage detected in the main battery is greater than a voltage detected in the auxiliary battery, a charge switch may control charging of the auxiliary battery with power from the main battery.

Operations 211 and 212 may be repeated until the power of the main battery is consumed, and the power information of the main battery becomes less than or equal to the power information of the auxiliary battery.

In 214, when the power information of the main battery is less than or equal to the power information of the auxiliary battery, the charging of the auxiliary battery is discontinued. For example, when the voltage detected in the main battery is less than or equal to the voltage detected in the auxiliary battery, the charge switch may discontinue the charging of the auxiliary battery with the power from the main battery.

When the charging of the auxiliary battery is discontinued, a battery to supply power to the hearing device may be selected as illustrated in operation 120 of FIG. 1.

FIG. 3 is a diagram illustrating an example of a method of selecting a battery of a hearing device. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. The above descriptions of FIGS. 1-2, is also applicable to FIG. 3, and is incorporated herein by reference. Thus, the above description may not be repeated here.

Referring to FIG. 3, in 321, a power information detector or a signal processor may compare power information of a main battery to a predetermined threshold value. In a non-exhaustive example, the predetermined threshold value may refer to information on a minimum amount of power needed to operate the hearing device. When the power information of the main battery is less than or equal to the predetermined threshold value, the hearing device may not operate. For example, the predetermined threshold value may be a minimum voltage required for operating the hearing device, for example, 0.9 V. Other predetermined thresholds, such as, for example, information on the minimum amount of power that may be retained by the main battery may be used without departing from the spirit and scope of the illustrative examples described.

In 322, when the power information of the main battery is greater than the predetermined threshold value, the main battery may supply power to the hearing device. Here, operations 321 and 322 may be repeated until the power of the main battery is consumed, and the power information of the main battery becomes less than or equal to the predetermined threshold value.

In 323, when the power information of the main battery is less than or equal to the predetermined threshold value, the auxiliary battery may supply power to the hearing device. When the main battery no longer supplies power for operating the hearing device, the auxiliary battery may supply power for operation of the hearing device.

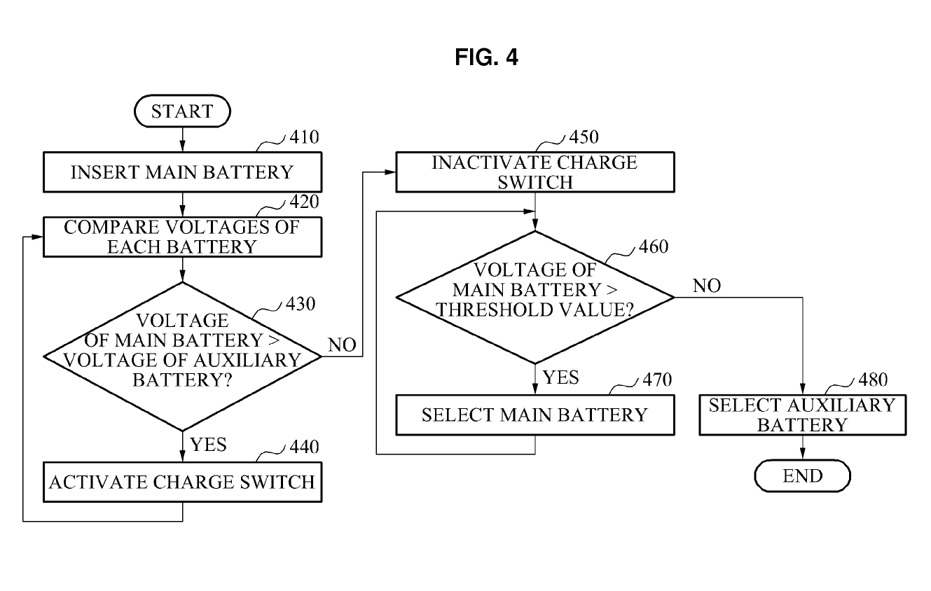

FIG. 4 is a diagram illustrating another example of a method of managing power of a hearing device. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently. The above descriptions of FIGS. 1-3, is also applicable to FIG. 4, and is incorporated herein by reference. Thus, the above description may not be repeated here.

Referring to FIG. 4, in 410, a main battery is inserted in the hearing device. Here, the main battery may include at least one of a primary cell and a secondary cell. The main battery may be easily attached to or detached from the hearing device. The main battery may be replaced when its power is discharged. The main battery may be inserted or replaced by a user of the hearing device.

In 420, when the main battery is detected to be inserted in the hearing device, a power information detector or a signal processor compares voltages of each battery. Each hearing device may include at least one main battery and at least one auxiliary battery. In 430, a voltage of the main battery may be compared to a voltage of the auxiliary battery.

In 440, when the voltage of the main battery is greater than the voltage of the auxiliary battery, the power information detector or the signal processor activates a charge switch. When the charge switch is activated, the auxiliary battery is charged with the power from the main battery, which is provided through the charge switch.

In 450, when the voltage of the main battery is less than or equal to the voltage of the auxiliary battery, the power information detector or the signal processor inactivates the charge switch. When the charge switch is inactivated, the charging of the auxiliary battery with the power from the main battery is discontinued.

In 460, a battery selector or the signal processor compares the voltage of the main battery to a predetermined threshold value. For example, the signal processor may determine whether the main battery has a sufficient amount of power to operate the hearing device based on the voltage of the main battery.

In 470, when the voltage of the main battery is greater than the predetermined threshold value, the battery selector or the signal processor selects the main battery to supply power to the hearing device. Operations 460 and 470 may be repeated until the power of the main battery is discharged and the voltage of the main battery becomes less than or equal to the predetermined threshold value.

In 480, when the voltage of the main battery is less than or equal to the predetermined threshold value, the battery selector or the signal processor selects the auxiliary battery to supply power to the hearing device. When the auxiliary battery is selected, the auxiliary battery, in lieu of the main battery, supplies power to the hearing device. The main battery may not have a sufficient amount of power to continue operation of the hearing device because the voltage of the main battery is less than or equal to the predetermined threshold value.

When the main battery is replaced by the user, the operation method may return to operation 410. While the hearing device is operating using the auxiliary battery, the user may replace the discharged main battery, and thus, the hearing device may operate without interruption.

FIG. 5 is a diagram illustrating an example of a configuration of a hearing device 500. The hearing device 500 illustrated in FIG. 5 may include a main battery 510, an auxiliary battery 520, a battery selector 530, a power information detector 540, a charge switch 550, and a signal processor 560.

The main battery 510 may store power for operating the hearing device 500 and for charging the auxiliary battery 520. The main battery 510 may charge the auxiliary battery 520 based on power information of each battery. The charge switch 550 may control the charging of the auxiliary battery 520. The main battery 510 may include a primary cell or a secondary cell. The secondary cell may be, for example, a rechargeable battery, and the secondary cell may be charged through wired or wireless power transmission. The main battery 510 may be easily attached to and detached from the hearing device 500 and may be replaced by a user.

The auxiliary battery 520 may store power for operating the hearing device 500. Here, the auxiliary battery 520 may be charged with the power from the main battery 510 based on the power information of each battery. The charge switch 550 may control the charging of the auxiliary battery 520. The auxiliary battery 520 may be similar to the secondary cell described above. The auxiliary battery 520 may be charged with the power from the main battery 510 or by an external power source through wired or wireless power transmission.

The battery selector 530 may select, between the main battery 510 and the auxiliary battery 520, a battery to supply power to the hearing device 500 based on power information of the main battery 510. The battery selector 530 may select between the main battery 510 and the auxiliary battery 520 as described above with reference to the drawing FIGS. 1-3, and the descriptions of FIGS. 1-3 is incorporated herein by reference. The battery selector 530 may be provided in a form of a circuit that is separated from the signal processor 560 or included in the signal processor 560, as shown in FIG. 6.

The power information detector 540 may detect the power information of the main battery 510 and power information of the auxiliary battery 520. The power information detector 540 may compare the power information of the main battery 510 to the power information of the auxiliary battery 520. When the power information of the main battery 510 is greater than the power information of the auxiliary battery 520, the power information detector 540 may activate the charge switch 550. The power information detector 540 may also transmit the power information detected from each battery to the battery selector 530.

In another example, the power information detector 540 may transmit, to the signal processor 560, the power information detected from each battery. Here, the signal processor 560 may determine whether to activate the charge switch 550 based on the detected power information.

The charge switch 550 may control charging of the auxiliary battery 520 with power from the main battery 510 based on the power information of the main battery 510 and the power information of the auxiliary battery 520. When the power information of the main battery 510 is greater than the power information of the auxiliary battery 520, the charge switch 550 may charge the auxiliary battery 520 with the power from the main battery 510. When the power information of the main battery 510 is less than or equal to the power information of the auxiliary battery 520, the charge switch 550 may discontinue charging of the auxiliary battery 520 with the power from the main battery 510.

In an example, the power information detector 540 may activate the charge switch 550 to charge the auxiliary battery 520 using the main battery 510. The power information detector 540 may also inactivate the charge switch 550 to discontinue charging the auxiliary battery 520 using the main battery 510.

In another example, the signal processor 560 may activate the charge switch 550 to charge the auxiliary battery 520 using the main battery 510. The the signal processor 560 may also inactivate the charge switch 550 to discontinue charging of the auxiliary battery 520 using the main battery 510.

The signal processor 560 may receive power from at least one of the main battery 510 or the auxiliary battery 520. The signal processor 560 may process an auditory signal. A battery to supply power to the signal processor 560 may be selected by the battery selector 530 or the signal processor 560. A detailed configuration of the signal processor 560 is provided with reference to FIG. 7.

FIG. 6 is a diagram illustrating another example of a configuration of a hearing device 600. The hearing device 600 may include a main battery 610, an auxiliary battery 620, a charge switch 650, and a signal processor 660. Here, the main battery 610 and the auxiliary battery 620 may be similar to the main battery 510 and the auxiliary battery 520, respectively, illustrated in FIG. 5.

The charge switch 650 may be activated or inactivated by the signal processor 660. When the charge switch 650 is activated, the auxiliary battery 620 may be charged using the main battery 610. When the charge switch 650 is inactivated, the charging of the auxiliary battery 620 using the main battery 610 may be discontinued.

The signal processor 660 may receive power from at least one of the main battery 610 and the auxiliary battery 620 and may process an auditory signal. The signal processor 660 may select a battery to receive power based on power information for the main battery 610. The signal processor 660 may determine whether to charge the auxiliary battery 620 based on the power information of the main battery 610 and power information of the auxiliary battery 620. For example, the signal processor 660 may detect power information of each battery in a manner similar to the power information detector 540 of FIG. 5.

FIG. 7 is a diagram illustrating an example of a signal processor 760 of a hearing device. The signal processor 760 may include a microphone (MIC) 761, an analog-to-digital converter (ADC) 762, a digital signal processor (DSP) 763, a digital-to-analog converter (DAC) 764, and a receiver (REC) 765.

As shown in FIG. 7, the MIC 761 may receive an auditory signal generated from an external source. The ADC 762 may convert the auditory signal input from an analog signal to a digital signal. The DSP 763 may process and amplify the converted auditory signal. The DAC 764 may convert the processed auditory signal to an analog signal. The REC 765, as a speaker, may play and provide the processed auditory signal to a user.

As illustrated in FIG. 6, the DSP 763 may receive power information of each battery detected by a power information detector, determine whether to charge an auxiliary battery, and select a battery to operate the hearing device.

In a general aspect, positioning multiple batteries in the hearing device may enable operation of the auxiliary battery even when the main battery is discharged. Thus, a situation where a hearing aid is rendered inoperable, due to a sudden discharge of the main battery, may be prevented. Also, the user of the hearing device may not need to carry a spare battery and thus, a number of batteries the user needs to carry may be reduced.

The processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of managing power of a hearing device, the method comprising:
determining, at a processor, to charge an auxiliary battery based on comparing power information of a main battery to power information of the auxiliary battery; and
selecting a battery to supply power to the hearing device based on the power information of the main battery.

2. The method of claim 1, wherein the determining to charge an auxiliary battery comprises determining to charge an auxiliary battery based on detecting the power information of the main battery and the power information of the auxiliary battery.

3. The method of claim 1, wherein the determining to charge an auxiliary battery comprises charging the auxiliary battery, in response to the power information of the main battery being greater than the power information of the auxiliary battery.

4. The method of claim 3, wherein the charging of the auxiliary battery comprises charging the auxiliary battery by supplying the power from the main battery to the auxiliary battery.

5. The method of claim 3, further comprising discontinuing the charging of the auxiliary battery, in response to the power information of the main battery being less than or equal to the power information of the auxiliary battery.

6. The method of claim 1, wherein the selecting of the battery to supply power comprises supplying power from the main battery to the hearing device, in response to the power information of the main battery being greater than a predetermined threshold value.

7. The method of claim 1, wherein the selecting of the battery to supply power comprises supplying power from the auxiliary battery to the hearing device, in response to the power information of the main battery being less than or equal to the predetermined threshold value.

8. A hearing device, comprising:
an auxiliary battery configured to store power for operating the hearing device;
a main battery configured to charge the auxiliary battery based on power information of the main battery and power information of the auxiliary battery; and
a battery selector configure to select a battery to supply power to the hearing device based on the power information of the main battery.

9. The device of claim 8, further comprising:
a power information detector configured to detect the power information of the main battery and the power information of the auxiliary battery.

10. The device of claim 8, further comprising:
a charge switch configured to control charging of the auxiliary battery with power from the main battery, in response to the power information of the main battery being greater than the power information of the auxiliary battery.

11. The device of claim 10, wherein the charge switch is further configured to discontinue the charging of the auxiliary battery with the power from the main battery, in response to the power information of the main battery being less than or equal to the power information of the auxiliary battery.

12. The device of claim 8, wherein the battery selector is configured to select the main battery to supply power to the hearing device.

13. The device of claim 8, wherein the battery selector is further configured to select the auxiliary battery to supply power to the hearing device, in response to the power information of the main battery being less than or equal to a predetermined threshold value.

14. The device of claim 8, wherein the power information comprises at least one of a voltage, a current, or a power level of each battery.

15. The device of claim 8, further comprising a signal processor configured to process an auditory signal by receiving power from at least one of the main battery or the auxiliary battery.

16. The device of claim 15, wherein the signal processor comprises a microphone (MIC), an analog-to-digital converter (ADC), a digital signal processor (DSP), a digital-to-analog converter (DAC), and a receiver (REC).

17. The device of claim 8, wherein the auxiliary battery is a rechargeable battery configured to be charged wirelessly.

18. The device of claim 8, wherein the main battery comprises a plurality of cells, and at least one cell is a rechargeable cell configured to be charged wirelessly.

19. A hearing device, comprising:
an auxiliary battery configured to store power for operating the hearing device;
a main battery configured to store power for operating the hearing device and for charging the auxiliary battery; and
a signal processor configured to process an auditory signal by receiving power from at least one of the main battery or the auxiliary battery.

20. The device of claim 19, wherein the signal processor is further configured to select a battery to operate the hearing device based on power information of the main battery and to determine whether to charge the auxiliary battery based on the power information of the main battery and power information of the auxiliary battery.
